(19) United States
(12) Patent Application Publication
(10) Pub. No.: US 2010/0243630 A1
(43) Pub. Date: Sep. 30, 2010

(54) Method for patterning the zinc oxide front electrode layer of a photovoltaic module

(76) Inventor: Walter Psyk, Muenchen (DE)

Correspondence Address: FLYNN THIEL BOUTELL & TANIS, P.C., 2026 RAMBLING ROAD, KALAMAZOO, MI, 49008-1631, US

(21) Appl. No.: 12/799,839

(22) Filed: Mar. 23, 2010

(30) Foreign Application Priority Data
Mar. 27, 2008 (DE) 10 2008 015 807.0

(51) Int. Cl. B23K 26/00

(52) U.S. Cl. 219/121.85

(57) ABSTRACT

For patterning a front electrode layer (3) made of zinc oxide deposited on a transparent, electrically insulating substrate (2) in the production of a photovoltaic module (1) there is used a pulsed solid-state laser (13) with a short pulse width which emits infrared radiation.

This invention relates to a method for patterning a front electrode layer made of zinc oxide deposited on a transparent, electrically insulating substrate, with a solid-state laser in the production of a photovoltaic module according to the preamble of claim 1.

In the production of a photovoltaic module there are deposited over a large area on the transparent, electrically insulating substrate, for example a glass plate, three functional layers, namely, a transparent front electrode layer, a semiconductor thin-film layer and a back electrode layer.

To form series-connected cells from these monolithic layers, the layers are patterned by separating lines e.g. with a laser, by mechanical methods or by chemical means.

The separating lines or grooves for patterning the front electrode layer are generally produced by laser radiation. The originally monolithic front electrode layer is thus separated into individual strips which are electrically separate from each other.

The front electrode layer comprises a transparent, electrically conductive metal oxide, for example zinc oxide (ZnO) or tin oxide (SnO₂).

Since tin oxide absorbs laser light in the infrared range, the tin oxide front electrode layer is typically patterned with a neodymium-doped yttrium aluminum garnet (Nd:YAG) solid-state laser or neodymium-doped yttrium vanadate (Nd:YVO₄) solid-state laser, which emits infrared radiation with a wavelength of 1064 nm.

Zinc oxide absorbs laser light in the ultraviolet range, so that the laser used for patterning a zinc oxide front electrode layer is typically a Nd:YAG or Nd:YVO₄ solid-state laser with the third harmonic frequency with a wavelength of 355 nm.

The patterning of the semiconductor layer, for example a silicon thin film, is likewise typically done with laser technology. The laser used is a Nd:YAG or Nd:YVO₄ solid-state laser with the second harmonic frequency with a wavelength of 532 nm, since the silicon thin film possesses high optical absorbance at this wavelength compared to the transparent front electrode layer.

For patterning the back electrode layer, mechanical methods (lift-off technology) and laser processes are used. In the mechanical method there is applied to the semiconductor layer e.g. a medium that masks the semiconductor layer during subsequent coating of the back electrode layer. In the following lift-off process, the masking medium is removed with the back electrode layer thereabove mechanically, for example with a water jet. The back electrode layer is thus separated into individual strips. However, patterning of the back electrode layer can also be done with a laser. Lasers typically used for patterning the back electrode layer are Nd:YAG or Nd:YVO₄ solid-state lasers with the second harmonic frequency (532 nm).

Since neodymium-doped solid-state lasers of the third harmonic frequency have considerably higher costs compared to neodymium-doped solid-state lasers with the fundamental wavelength of 1064 nm, the laser patterning of a zinc oxide front electrode layer is many times more expensive than that of a front electrode layer made of tin oxide. Moreover, the solid-state laser with the third harmonic frequency must be regularly serviced by repositioning the aging crystal producing the third harmonic frequency.

It is therefore the object of the invention to substantially reduce the costs for patterning a front electrode layer made of zinc oxide in the industrial production of photovoltaic modules.

This is obtained according to the invention by patterning the zinc oxide front electrode layer using a pulsed laser with a short pulse width of less than 500 ns which emits infrared radiation.

Although zinc oxide (ZnO) does not absorb laser light in the infrared range, the zinc oxide layer deposited on the transparent substrate, for example a glass plate, can surprisingly be patterned with the short laser pulses of an infrared-emitting laser, in particular when the laser beam is focused on the front electrode layer through the transparent substrate for patterning the front electrode layer. Due to the short pulse width of the laser pulses, the laser power is first deposited at the interface between the transparent substrate and the zinc oxide layer. A certain proportion of the zinc oxide material at said interface is vaporized by the laser power, while the rest of the laser power partly melts the zinc oxide. The vapor pressure then causes the zinc oxide material heated in the laser focus to be blasted off the substrate surface, in any case removed thermomechanically.

The zinc oxide overburden material removed during patterning of the front electrode layer is preferably extracted by a laser dust extraction device, which transports it to a filter plant. Thus, the zinc oxide in the separating lines or grooves produced by the laser is removed or ablated and the originally monolithic zinc oxide layer divided into individual, mechanically and electrically separate strips.

It has proved to be necessary here to pattern the zinc oxide front electrode layer using short-pulse lasers with a pulse width of less than 500 ns which emit infrared radiation. Thus, Nd:YAG lasers with greater pulse widths of up to 900 ns partly melt the zinc oxide material, but do not remove it without residue from the separating line.

The laser used according to the invention emits infrared radiation, that is, radiation with a wavelength of at least 800 nm, preferably 1000 nm and more, in particular a solid-state laser emitting in the near infrared range being used. The solid-state laser can also be a fiber laser or a disk laser.

The solid-state laser is preferably an yttrium vanadate (YVO₄) laser. Instead, the host crystal can also be YAG for example. It is preferable to employ neodymium for doping, i.e. to use a solid-state laser with a wavelength of 1064 nm. It is also possible to employ erbium, ytterbium or another element for doping the laser. A neodymium-doped yttrium vanadate laser (Nd:YVO₄ laser) or neodymium-doped YAG laser (Nd:YAG laser) is particularly preferred.

The pulse width of the pulses of the pulsed laser is generally less than 200 ns. It is thus possible to pattern the zinc oxide front electrode layer using for example a Nd:YVO₄ solid-state laser with a fundamental wavelength of 1064 nm with pulse widths of 1 to 50 ns, in particular 5 to 20 ns. It is also possible to use so-called long-pulse YVO₄ solid-state lasers with a pulse width of up to approx. 100 ns for patterning. The laser radiation of the Nd:YVO₄ solid-state laser with its fundamental wavelength of 1064 nm is ideally focused on the zinc oxide layer through the transparent substrate. However , the laser radiation can alternatively also be focused directly on the zinc oxide front electrode layer.

According to the invention it is thus possible to produce narrow, for example 10 to 100 μm wide, separating lines in the zinc oxide front electrode layer in order to produce the electrically separate solar cells for the integrated series connection.

The patterning of the zinc oxide front electrode layer for example with the fundamental wave of the Nd:YVO₄ laser is preferably done in the CW (continuous wave)-pumped and quality-switched (Q switch) mode. The laser power deposited in the zinc oxide layer can be so controlled that the zinc oxide in the separating lines can be removed without damaging the substrate, for example the glass plate.

The invention will hereinafter be explained in more detail by way of example with reference to the drawing. Therein are shown schematically and in cross section:

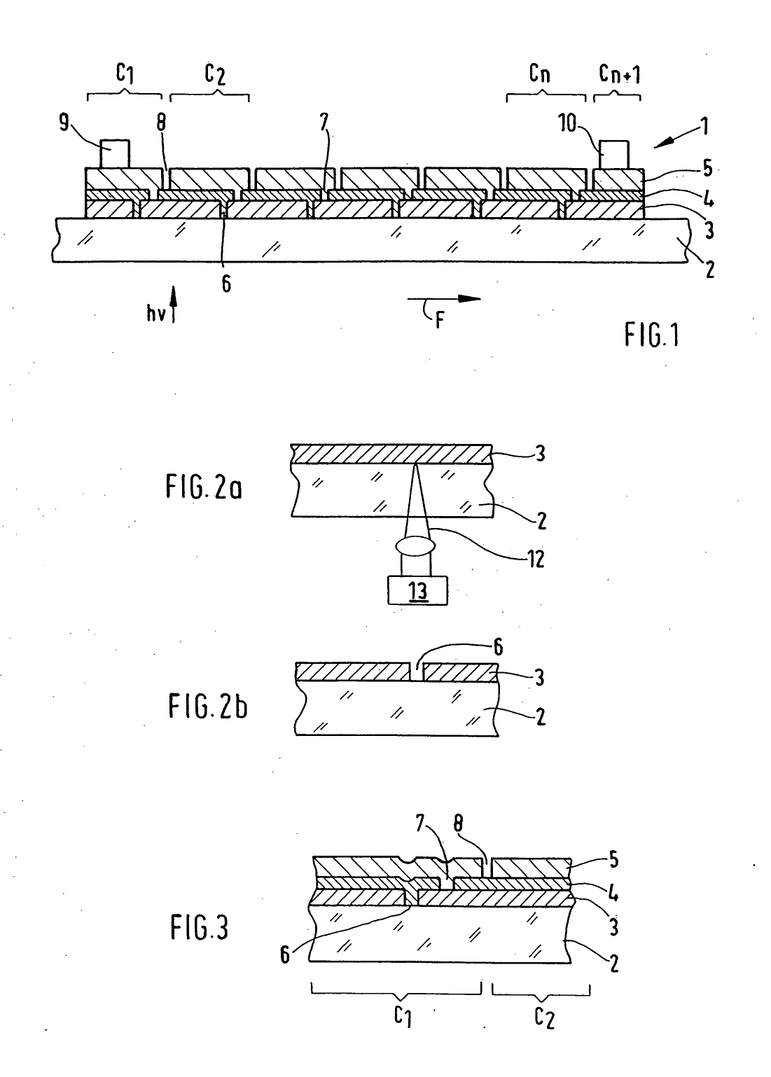

FIG. 1 a photovoltaic module;

FIGS. 2a and 2b the production of the patterned front electrode layer of the module; and

FIG. 3 the series connection of the single cells C₁ and C₂ according to FIG. 1.

According to FIG. 1, the photovoltaic module 1 has a transparent substrate 2, for example a glass plate, having deposited thereon, one on the other, the three functional layers, namely, a transparent front electrode layer 3, a semiconductor thin-film layer 4 and a back electrode layer 5.

The module 1 comprises individual strip-shaped cells C₁, C₂, . . . Cₙ, Cₙ₊₁ which are series-connected and extend perpendicular to the current flow direction F. For this purpose, the front electrode layer 3 is interrupted, and thus patterned, by separating lines 6, the semiconductor layer 4 by separating lines 7, and the back electrode layer 5 by separating lines 8.

According to FIG. 1, the back electrode layer 5 of one cell C₁, Cₙ thus contacts the front electrode layer 3 of the adjacent cell C₂, Cₙ₊₁ through the separating line 7 in the semiconductor layer 4, thereby connecting the negative pole of one cell C₁, Cₙ with the positive pole of the adjacent cell C₂, Cₙ₊₁.

The current produced by the photovoltaic module 1 is collected by the contacts 9, 10 on the outermost cells C₁, Cₙ₊₁. On the back of the module 1 with the contacts 11, 12 there is provided a back protection (not shown) made of plastic or another electrically insulating material.

FIG. 3 shows the series connection of two adjacent cells by the example of the cells C₁ and C₂ according to FIG. 1.

The series-connected cells C₁ and C₂ are produced as follows.

Starting out from a glass substrate 2 coated with zinc oxide as the front electrode layer 3, there are produced according to FIG. 2a with the focused laser beam 12 of the pulsed laser 13 which emits infrared radiation, in particular a Nd:VO₄ laser with a wavelength of 1064 nm and a pulse width between 5 and 20 ns, the separating lines 6 for patterning the front electrode layer 3 according to FIG. 2b, namely, by melting and vaporization of the zinc oxide by the laser power deposited at the interface between glass substrate 2 and zinc oxide layer 3. In doing so, the laser beam 12 is focused on the front electrode layer 3 through the glass substrate 2. This causes separating lines 6 with a width of for example about 50 μm to be produced. Instead of through the transparent substrate 2, the laser beam can also be focused directly, that is, on the side of the front electrode layer 3 facing the substrate 2, i.e. the layer side, for patterning the front electrode layer 3.

On the thus patterned front electrode layer 3 there is subsequently deposited the semiconductor layer 4, for example made of amorphous, nano-, micro- or poly-crystalline silicon or another semiconductor, for example cadmium tellurium, which is in turn patterned with the separating lines 7, whereupon the preferably metallic back electrode layer 5 is deposited, which is then in turn patterned with the separating lines 8.

1. A method for patterning a front electrode layer (3) made of zinc oxide deposited on a transparent, electrically insulating substrate (2), with a solid-state laser (13) for producing a photovoltaic module (1) which has on the front electrode layer (3) a semiconductor layer (4) and a back electrode layer (5) which are in turn patterned in order to form series-connected cells (C₁, C₂, . . . Cₙ, Cₙ₊₁) with the patterned front electrode layer (3), characterized in that a pulsed laser (13) with a short pulse width of less than 500 ns which emits infrared radiation is used for patterning the front electrode layer (3).

2. The method according to claim 1, characterized in that the pulse width of the laser (13) is less than 200 ns.

3. The method according to claim 1, characterized in that the pulse width is less than 50 ns.

4. The method according to claim 1, characterized in that the pulse width of the laser (13) is less than 20 ns.

5. The method according to claim 1, characterized in that the laser is CW-pumped and the pulsing is done in the quality-switched mode.

6. The method according to claim 1, characterized in that a neodymium-doped solid-state laser with a wavelength of 1064 nm is used.

7. The method according to claim 6, characterized in that a neodymium-doped yttrium vanadate garnet laser or yttrium aluminum garnet laser is used.

8. The method according to claim 1, characterized in that the laser beam (12) is focused on the front electrode layer (3) through the transparent substrate (2) for patterning the front electrode layer (3).

9. The method according to claim 1, characterized in that the laser beam (12) is focused into the front electrode layer (3) from the layer side for patterning the front electrode layer (3).

10. The method according to claim 1, characterized in that the zinc oxide overburden material removed during patterning of the front electrode layer (3) is extracted.
